(19) United States
(12) Patent Application Publication
(10) Pub. No.: US 2025/0069125 A1
(43) Pub. Date: Feb. 27, 2025

(54) IMAGE FORMING DEVICE ISSUING NOTIFICATION REGARDING PRICE PLAN BASED ON CONSUMPTION AMOUNT OF CONSUMABLE MATERIAL

(71) Applicant: BROTHER KOGYO KABUSHIKI KAISHA, Nagoya (JP)

(72) Inventor: Tetsuya OKUNO, Nagoya (JP)

(21) Appl. No.: 18/780,751

(22) Filed: Jul. 23, 2024

(30) Foreign Application Priority Data
Aug. 25, 2023 (JP) 2023-137498

(51) Int. Cl. G06Q 30/0283; G06F 3/12

(52) U.S. Cl. CPC G06Q 30/0283; G06F 3/1219; G06F 3/1229

(57) ABSTRACT

An image forming device includes a printing engine, a notification member, and a controller. The printing engine is configured to print an image on a sheet. The controller performs acquiring a consumption status including information on a consumption amount of consumable material consumed by the printing engine. The controller performs a notification process to control the notification member to issue a notification based on the consumption amount of consumable material. The notification includes notification information related to a subject price plan in which a fee is set for consumption of consumable material.

### REFERENCE TO RELATED APPLICATIONS

This application claims priority from Japanese Patent Application No. 2023-137498 filed on Aug. 25, 2023. The entire content of the priority application is incorporated herein by reference.

### BACKGROUND ART

There are conventional services that charge a fee in accordance with the consumption of consumables used in image formation on an image forming device. A user applies for the use of a printing service. To use the service, the user must pay a fee for the ability to print up to a predetermined number of sheets of paper, for example. Here, the paper constitutes the consumable used in image formation. Accordingly, the user can consume paper up to the predetermined number of printable sheets.

### SUMMARY

However, users may have a choice of subscription plans that charge a fee for the consumption of consumables, and the subscription plan most suitable for an individual user depends on how the user uses the image forming device.

In view of the foregoing, it is an object of the present disclosure to provide an image forming device that assists the user in selecting a subscription plan suitable for the way in which the user uses the device.

In view of the foregoing, it is an object of the present disclosure to provide an image forming device. The image forming device includes a printing engine, a notification member, and a controller. The printing engine is configured to print an image on a sheet. The controller is configured to perform: acquiring a consumption status including information on a consumption amount of consumable material consumed by the printing engine; and a notification process to control the notification member to issue a notification based on the consumption amount of consumable material, the notification including notification information related to a subject price plan in which a fee is set for consumption of consumable material.

In order to attain the above and other objects, the present disclosure provides an image forming system. The image forming system includes an image forming device and a processing device. The image forming device includes a printing engine and a notification member. The printing engine is configured to print an image on a sheet. The processing device is configured to communicate with the image forming device. The processing device includes a controller. The controller is configured to perform: acquiring a consumption status including information on a consumption amount of consumable material consumed by the printing engine; and a sending process to send, to the image forming device, a notification based on the consumption amount of consumable material, the notification including notification information related to a subject price plan in which a fee is set for consumption of consumable material. Upon receipt of the notification from the processing device, the notification member presents the notification information in the notification.

In order to attain the above and other objects, the present disclosure provides a processing device. The processing device is configured to communicate with the image forming device. The processing device includes a controller. The controller is configured to perform: acquiring a consumption status including information on a consumption amount of consumable material consumed by a printing engine in an image forming device; and a notification process to send, to an external device, a notification including notification information based on the consumption amount of consumable material so that the external device presents the notification information, the notification information being related to a subject price plan in which a fee is set for consumption of consumable material.

In the above structures, the user can be assisted in selecting a subscription plan suitable for the way in which the user uses the device.

### BRIEF DESCRIPTION OF DRAWINGS

FIG. 1 is a block diagram illustrating a structure of a printer according to an embodiment.

FIG. 2 is a conceptual diagram illustrating a determination period for use in determining a recommended plan.

FIG. 3A is an explanatory diagram illustrating an example of a guidance message showing a recommended plan selected based on the determination period shown in FIG. 2.

FIG. 3B is an explanatory diagram illustrating another example of a guidance message.

FIG. 4 is a flowchart illustrating a process executed by a controller shown in FIG. 1.

FIG. 5 is a block diagram illustrating a structure of a printer according to an embodiment.

FIG. 6 is an explanatory diagram illustrating an example of a guidance message recommending a user subscribing to a subscription plan.

FIG. 7 is a block diagram illustrating a structure of a printing system according to variations.

### DESCRIPTION

### First Embodiment

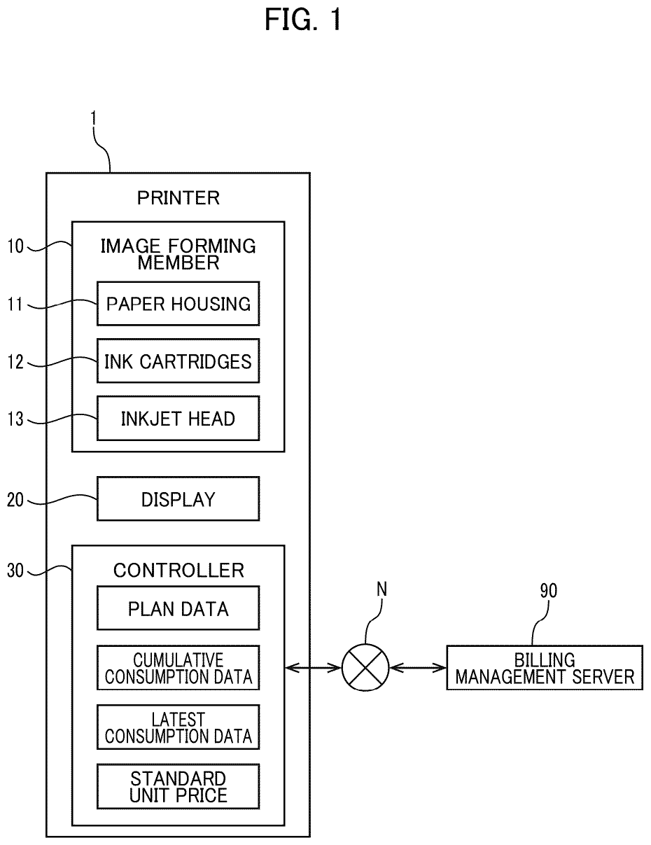

A printer 1 according to an embodiment will be described while referring to FIGS. 1-4.

The printer 1 corresponds to the “image forming device” of the present disclosure. As shown in FIG. 1, the printer 1 has an image forming member 10, a display 20, and a controller 30.

The image forming member 10 has a paper housing 11 that can accommodate printing paper, ink cartridges 12 that store ink, and an inkjet head 13. The image forming member 10 forms images on printing paper under control of the controller 30 by ejecting the ink stored in the ink cartridge 12 from the inkjet head 13 onto the printing paper supplied from the paper housing 11. That is, the image forming member 10 is a print engine or a printing assembly that perform printing operations.

The paper housing 11 can accommodate multiple sizes and types of printing paper. Examples of paper sizes include A4 and B5. Examples of paper types include plain paper, recycled paper, high-quality paper, and glossy paper. The paper housing 11 is configured to accommodate one or more of these sizes and types of printing paper simultaneously.

The ink stored in the ink cartridges 12 may be of multiple types that differ in color, material, and the like. For example, the ink may be in colors such as cyan, magenta, yellow, and black and of types such as pigment-based ink and dye-based ink. Each ink cartridge 12 accommodates one or more of these types and colors of ink simultaneously.

The display 20 corresponds to the “notification member. The display 20 displays text, images, and the like on the screen, whereby the display 20 can provide various information to the user.

The controller 30 is provided with hardware, such as a central processing unit (CPU); a storage configured of a read-only memory (ROM) and/or a random-access memory (RAM); and/or an application-specific integrated circuit (ASIC). The ROM stores program data executed by the CPU and the ASIC, and other data. The RAM stores instruction data for image formation described later, and data used by the CPU to execute programs. The CPU and ASIC are processors. The CPU and ASIC, which are hardware, execute various processes including processes to control the operations of the image forming member 10 and the display 20 in accordance with the program data, which is software stored in the ROM and RAM, and other data.

For example, the controller 30 controls the image forming member 10 to form images on paper based on image data received from an external PC or the like. The image data specifies the content of image formation to be performed by the image forming member 10. The image data includes data specifying the content of images to be formed on printing paper, as well as data indicating the content of various settings. The settings include the size and type of printing paper, the printing quality, and the number of sheets to be printed. The controller 30 controls the image forming member 10 to form images in accordance with the settings specified in the image data. At this time, the controller 30 counts the number of sheets of printing paper consumed in the image forming process. The counting results are stored as cumulative consumption data indicating the cumulative consumption amount of printing sheets (papers). For example, the cumulative consumption amount of printing sheets (papers) is the total number of printed sheets. This function of the controller 30 acquiring the cumulative consumption amount corresponds to the function of the “status acquisition” in the present disclosure. Further, the cumulative consumption amount corresponds to the “consumption status” of the present disclosure. The printing sheets or printing papers are examples of a consumable material.

The printer 1 may also be provided with a scanning member (or a scanner, a scanning engine, a scanning assembly) for reading the content of an original document. In this case, the image data used for image formation may be data obtained through a reading operation by the scanning member.

The present embodiment assumes there are multiple subscription plans for using the printer 1 offered by the manufacturer of the printer 1 or the like. In each subscription plan, the manufacturer or other entity provides the user with ink cartridges 12 and charges a fee based on the number of sheets of printing paper consumed in image formation. Each subscription plan assumes that the user uses a certain number of sheets of printing paper per month.

Table 1 below shows an example of subscription plans. Plans 1 through 3 in Table 1 correspond to the “first detailed plans” or “first-type specific plans” and are flat-rate (or flat-fee) plans having a set monthly fee. The monthly fee corresponds to the “first charge” and is a fixed charge per month. Each of these plans sets an upper limit on the number of sheets of printing paper to be consumed per month. This upper limit corresponds to the “first reference value”. The upper limit is a value of sheets per month. A surcharge, which corresponds to the “second charge”, is also set for the consumption of printing sheet (paper) that exceeds this upper limit. The surcharge is determined according to a usage-based system that charges an amount per sheet. The surcharge is a value of Yen per sheet. A determination reference value is also associated with each plan. The determination reference value is a value of sheets per month (sheets/month), in use for a determination reference. This determination reference value will be described later. Plan 1 has the lowest monthly fee, the lowest upper limit, and the highest surcharge among plans in the table 1. The monthly fee and upper limit increase while the surcharge decreases in the order of Plans 1, 2, and 3. The manufacturer or other entity may provide ink cartridges 12 either in response to user requests or automatically in accordance with the ink consumption status. For each flat-rate plan, the surcharge (yen/sheet) is larger than a value obtained by dividing the flat rate (yen/month) by the upper limit (sheets/month). For example, for Plan 1, the surcharge 10 (yen/sheet) is larger than 7.5 (yen/sheet) that is a value obtained by dividing the flat rate 100 (yen/sheet) by the upper limit 40 (sheets/month).

TABLE 1

| | | | | Determination |
|---|---|---|---|---|
| Flat-rate plan | Monthly fee | Upper limit | Surcharge | reference value |
| Plan 1 | ¥300 | 40 | ¥10 | 10 |
| Plan 2 | ¥500 | 80 | ¥8 | 20 |
| Plan 3 | ¥700 | 200 | ¥5 | 30 |

Table 2 below shows another example of subscription plans. Plans 4 through 6 in Table 2 correspond to the “second detailed plans” or “second-type specific plans” of the present disclosure and are usage-based plans in which the user purchases authorization to perform image formation on a predetermined number of sheets of printing paper. With these usage-based plans, the user can purchase authorization for printing a predetermined number of sheets of printing paper in one payment. In other words, the usage-based plans in this embodiment are prepaid plans. Users purchase any one of the plans at a time of their own choosing. In Table, 2, a fee is a fee to be paid for the predetermined number of sheets in one payment, a sheet number indicates the number of sheets to be purchased and thus the predetermined number of sheets purchased in one payment. The unit price is a fee per sheet number (yen/sheet). Hereinafter, the number of sheets to be purchased may be referred to as the number of purchase sheets. Plan 4 has the smallest number of purchase sheets, but the highest unit price per sheet of printing paper. The number of purchase sheets increases while the unit price decreases in the order of Plans 4, 5, and 6. The determination reference value is a value of sheets per month (sheets/month), in use for a determination reference. The purchase price is equal to a value obtained by multiplying the number of purchase sheets by the unit price.

TABLE 2

| | | | | Determination |
|---|---|---|---|---|
| Usage-based plan | Fee | Sheet number | Unit price | reference value |
| Plan 4 | ¥500 | 50 | ¥10 | 20 |
| Plan 5 | ¥900 | 100 | ¥9 | 40 |
| Plan 6 | ¥2,000 | 250 | ¥8 | 80 |

The printer 1 is connected to a billing management server 90 through a communication network N such as Internet. For flat-rate plans, the controller 30 transmits cumulative consumption data indicating the cumulative consumption amount of printing sheets (papers) to the billing management server 90 together with a user ID. Based on the cumulative consumption data received from the printer 1, the billing management server 90 obtains each amount of printing sheet (paper) consumption per monthly service period. Here, the monthly service period is a period corresponding to the flat-rate plans. The amount of printing paper consumed for each service period is calculated based on the cumulative consumption amount acquired at the starting point of the service period and the cumulative consumption amount acquired at the ending point of the service period. The billing management server 90 calculates the fee for each service period based on the amount of printing paper consumed that service period. The billing management server 90 bills each user based on the fee calculated for the corresponding user.

For usage-based plans, on the other hand, the billing management server 90 determines whether the amount of consumed printing sheet (paper) exceeds the number of purchase sheets. When the billing management server 90 determines that the amount of consumption does not exceed the purchased number of sheets, the billing management server 90 transmits, to the printer 1, an instruction permitting image formation. However, when the billing management server 90 determines that the consumption amount exceeds the number of purchase sheets, the billing management server 90 transmits to the printer 1 an instruction prohibiting image formation.

The printer 1 executes or terminates image formation in accordance with the instruction received from the billing management server 90. The printer 1 can also send an inquiry to the billing management server 90 together with a user ID to inquire about the subscription status of plans for that user. In response to this inquiry, the billing management server 90 returns information indicating whether the user corresponding to the user ID is currently subscribed to one of the plans. In other words, this information indicates whether the user (or an account of user) corresponding to the user ID currently activates one of the plans, that is, the information indicates whether the user has applied for one of the plans. When the user corresponding to the user ID is currently subscribed to one of the plans, the server 90 also returns the information specifying the plan to which the user is subscribed from among Plans 1 through 6 together with the information indicating that the user is currently subscribed to one of the plans.

As described above, each of the above plans has a set fee for the consumption of printing sheet (paper). However, the plans differ from each other in the per sheet rate and other conditions. The user considers whether to subscribe to one of the plans and, when subscribing, which plan to choose. However, since users can use the printer 1 in various ways, it is not always clear what advantages each of the plans can offer each type of user.

Therefore, the following configuration is used in the present embodiment for recommending to users a plan that is most appropriate for the way the user uses the printer 1.

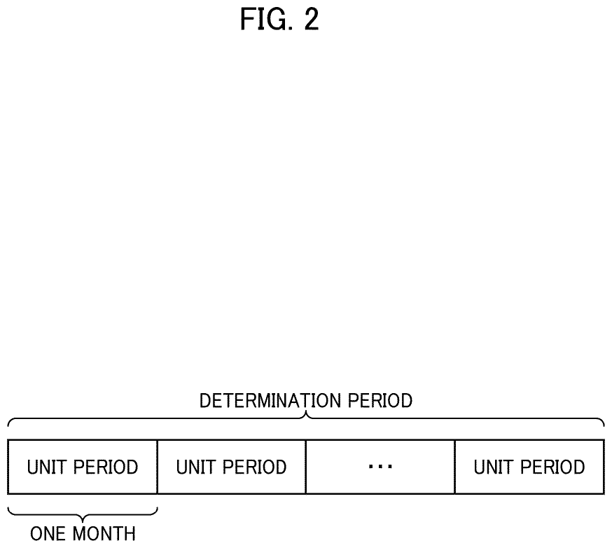

The controller 30 maintains plan data representing the content of Tables 1 and 2 described above. This plan data includes determination reference values having a one-on-one correspondence to each plan. The controller 30 also maintains the latest consumption data indicating the most recent amounts of printing paper consumed by the user in a predetermined determination period (hereinafter called the “latest consumption amounts”). The predetermined determination period includes a plurality of consecutive month-long unit periods, as shown in FIG. 2. The latest consumption amount is calculated based on the cumulative number of consumed sheets acquired at the starting point of each unit period and the cumulative number of consumed sheets acquired at the ending point of each unit period. Table 3 is an example of values specified in the latest consumption data. In this example, the determination period consists of three unit periods. “January consumption” denotes the amount of consumption (the number of consumed sheets) in the initial unit period within this determination period. “February consumption” denotes the amount of consumption (the number of consumed sheets) in the next unit period. “March consumption” denotes the amount of consumption (the number of consumed sheets) in the next unit period. The average consumption amount is the number of consumed sheets found by averaging the consumption amount per unit period in the determination period. In this example, the average consumption amount is a value obtained by dividing a total number of consumed sheets during the determination period (3 months, 3 unit periods) by “3” that is the number of unit periods within the determination period. Table 3 shows an example of the latest consumption amount for a User 1 and a User 2 who have not yet subscribed to a plan.

TABLE 3

| User | January | February | March | |
|---|---|---|---|---|
| (not subscribed) | consumption | consumption | consumption | Average |
| User 1 | 30 | 35 | 40 | 35 |
| User 2 | 45 | 10 | 5 | 20 |

The controller 30 selects a recommended plan from among the plurality of subscription plans based on the usage pattern for the printer 1 indicated by the latest consumption amounts and the determination reference value for each plan and displays information on the recommended plan on the display 20. This process corresponds to the “plan notification process” of the present disclosure. The controller 30 selects a plan based on the following conditions (1) through (3).

### <Condition for Selecting a Flat-Rate Plan>

(1) The consumption amount of printing sheets (papers) in each unit period of the determination period (each latest consumption amount) must fall within a fluctuation range specified by the determination reference value and the upper limit for one of the flat-rate plans.

Specifically, as indicated in Formula 1 below, the consumption amount of printing sheets (papers) in each unit period within the determination period must fall within a range from the value obtained by subtracting the determination reference value from the upper limit to the upper limit. Because the determination reference values have a one-on-one correspondence to Plans 1-3 described above, the ranges found from these values also have a one-on-one correspondence to Plans 1-3. Each range corresponds to the “fluctuation range” and “variation range” of the present disclosure. The value obtained by subtracting the determination reference value from the upper limit corresponds to the “lower limit” of the present disclosure. The lower limit and the upper limit for Formula 1 correspond to the “second reference values” of the present disclosure.

$$( upper limit ) - ( determination reference value ) \leq ( consumption amount of printing sheet in each unit period ) \leq ( upper limit ) \qquad Formula 1$$

Satisfying this condition indicates that the amount of printing paper consumed in each unit period is of a certain quantity and is maintained within the fluctuation range indicated by the determination reference value throughout the entire determination period. This case indicates that the user uses a certain number of sheets of printing paper per month and that the number of sheets used is unlikely to fluctuate significantly from month to month, making it unlikely that surcharges will be applied. Such a usage pattern with the printer 1 is suitable for a flat-rate plan.

### <Condition for Selecting a Usage-Based Plan>

(2) The latest consumption amount in the determination period must not satisfy condition (1), and the consumption amount of printing sheets (papers) for at least one of the unit periods (at least one latest consumption amount) must exceed the determination reference value for one of the usage-based plans, as indicated by the following Formula 2.

$$( determination reference value for one of the usage - based plans ) < ( consumption amount of printing sheet for a unit period ) \qquad Formula 2$$

Satisfying this condition indicates that the user uses a certain number of sheets of printing paper per month and that the number of sheets consumed varies to some extent from month to month. Such a usage pattern for the printer 1 is suitable for a usage-based plan. The plan having the largest determination reference value among usage-based plans that satisfies Formula 2 is a candidate to be selected as the recommended plan. The determination reference value for a usage-based plan corresponds to the “upper threshold value” or “threshold value” of the present disclosure.

### <Condition Both for Selecting a Flat-Rate Plan and for Selecting a Usage-Based Plan>

(3) The cost with a new subscription or a change of plan must be lower than the projected cost of continuing the current arrangement.

The projected cost is a value for the cost estimated in a process performed by the controller 30 (corresponding to the “cost estimation process” of the present disclosure). This condition is evaluated according to the following two cases, depending on the plan subscription status of the user. As described above, the user's plan subscription status is based on information that the controller 30 acquires from the billing management server 90.

The first case involves changing plans. That is, the user is currently subscribed to one of the subscription plans and is expected to select the recommended plan and switch to the recommended plan from the current subscription. In other words, the first case may be a case that an account of the user currently has a subscription to a price plan. One exception in which condition (3) would not be used is when the current subscription plan is a usage-based plan and the recommended plan is also a usage-based plan. In a conceivable case that condition (3) is applied in such a case, the only acceptable change would be a change to Plan 6 because Plan 6 has the lowest unit cost among the usage-based plans.

Except for the above exception, the projected cost based on the current plan is compared to the cost based on the recommended plan. When the current plan is one of the flat-rate plans and the recommended plan is one of the usage-based plans, the cost of the current flat-rate plan is set to the monthly fee. For example, the cost of Plan 2 is 500 yen/month. The cost of a usage-based plan is the average consumption amount per unit period in the determination period multiplied by the unit price. For example, the cost of Plan 5 based on the latest consumption amounts of User 1 in Table 3 is 9 yen/sheet*35 sheets/month=315 yen/month. Thus, condition (3) is satisfied when the cost of the candidate recommended plan is less than the projected cost of the current plan according to this cost calculation. In the first case, the projected cost (projected fee) is calculated based on the current price plan.

When the current plan is one of the flat-rate plans and the recommended plan is another one of the flat-rate plans, the cost of the current flat-rate plan is set to a sum of the monthly fee of that plan and the total surcharge. Here, the total surcharge is a product of the surcharge (yen/sheet) (see Table 1) and a difference obtained by subtracting the upper limit from the average consumption amount per unit period in the determination period. That is, the difference is the average consumption amount exceeding the upper limit. In this case, the cost of the recommended plan is set to the flat rate of that plan. For example, when the current flat-rate plan is Plan 1 and the average consumption amount per unit period is 70 sheets, Plan 2 is a candidate for the recommended plan because the consumption amount of 70 sheets is within the range of Plan 2 according to condition (1). In this case, the total surcharge of current Plan 1 is equal to 300 (=10*(70−40)) yen, and the cost of Plan 1 is equal to 600 (=300+300) yen. Because the projected cost of Plan 2 is 500 Yen, condition (3) is satisfied for Plan 2.

The second case involves a new subscription. That is, the user is not currently subscribed to any subscription plan. In other words, the second case may be a case that the account of the user currently has no subscription to any price plan. In this case, the projected cost is calculated as indicated in Formula 3 below based on the user's latest consumption amounts. Here, the controller 30 maintains a standard unit price for each plan. The standard unit price corresponds to the standard cost of ink used for printing one sheet of paper when the user is not subscribed to a plan, i.e., when the user is printing with commercially sold ink cartridges 12.

$$( projected cost ) = ( average consumption amount per month ) * ( standard unit price ) \qquad Formula 3$$

When the second case is under a situation that the target account currently has no subscription to any price plan, the projected cost (projected fee) may be a fee projected under an assumption that the second situation is maintained.

This condition is satisfied when the cost based on the candidate recommended plan is less than the projected cost. The cost based on the candidate recommended plan is derived in the same manner described in the first case.

The controller 30 sets the recommended plan to a flat-rate plan from among Plans 1-3 that satisfies conditions (1) and (3). In the case of User 1 in Table 3, for example, the consumption amount for each of the months January, February, and March satisfies the formula 1 in condition (1) for Plan 1. Therefore, the candidate for the recommended plan is Plan 1. The cost for a subscription to Plan 1 is 300 yen/month. On the other hand, the projected cost for User 1, who is not subscribed to a plan, is calculated using formula 3 of condition (3). In a case that the standard unit price is 10 yen/sheet, the projected cost is 10 yen/sheet*35 sheets/month=350 yen/month. Therefore, condition (3) is satisfied and, hence, Plan 1 is the recommended plan for User 1.

In the case of User 2 in Table 3, formula 1 in condition (1) is not satisfied for any of Plans 1-3. On the other hand, the amount of printing paper consumed in the first unit period among all unit periods of the determination period exceeds the determination reference values for both Plan 4 and Plan 5 but does not exceed the determination reference value for Plan 6. In this case, the candidate for the recommended plan is Plan 5, which has the largest determination reference value satisfying formula 2 of condition (2). The cost of subscribing to Plan 5 based on the latest consumption amounts of User 2 is 9 yen/sheet*20 sheets/month=180 yen/month. On the other hand, since User 2 is not subscribed to a plan, the projected cost for User 2 is calculated using formula 3 of condition (3). When the standard unit price is 10 yen/sheet, the projected cost is 10 yen/sheet*20 sheets/month=200 yen/month.

After determining the recommended plan, the controller 30 calculates the amount of savings the user can expect when subscribing to that plan. The amount of savings is calculated by subtracting the cost based on the recommended plan from the projected cost of maintaining the current arrangement. The controller 30 then displays a guidance message on the display 20 informing the user of the recommended plan.

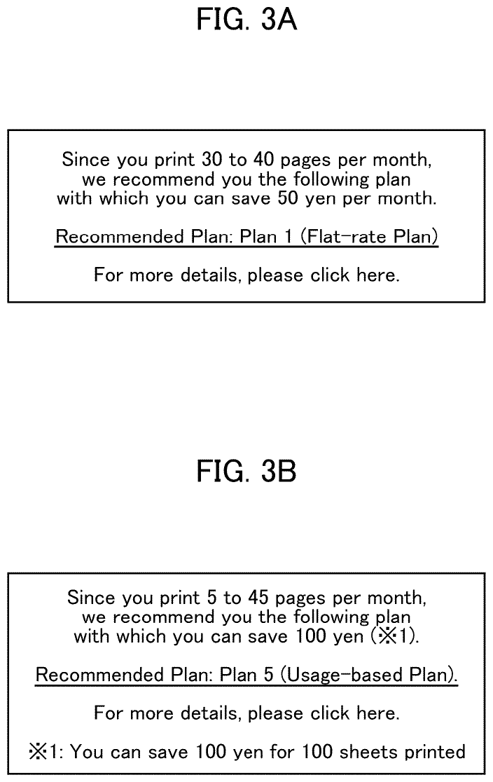

FIG. 3A shows a sample message for User 1 in Table 3. This message indicates that Plan 1 of the flat-rate plans is selected as the recommended plan, the text “Since you print 30 to 40 pages per month” based on the latest consumption information, and information on the amount the user can save. The amount of savings in this example is 50 yen, which is found by subtracting the cost of 300 yen/month based on the recommended plan from the projected cost of 350 yen/month for the current arrangement.

FIG. 3B shows a sample message for User 2 in Table 3. This message indicates that Plan 5 of the usage-based plans is selected as the recommended plan and includes the text “Since you print 5 to 45 pages per month” based on the latest consumption information, and information on the amount the user can save. The amount of savings in this example is found by subtracting the cost of the recommended plan from the projected cost when using 100 sheets of printing as a guideline. The projected cost, assuming a standard unit price of 10 yen/sheet, is 10 yen/sheet*100 sheets=1000 yen. The cost based on the recommended plan is 9 yen/sheet*100 sheets=900 yen using the unit price for Plan 5. Accordingly, the amount of savings is 100 yen. In other words, the user can save 100 yen for every 100 sheets printed.

A guidance message recommending a plan for a user already subscribed to one of the plans similarly includes information on which plan is selected as the recommended plan, and the amount of savings that is possible (except in the exception case described above). The amount of savings is calculated by subtracting the cost based on the recommended plan from the projected cost based on the current plan. For example, suppose that Plan 3 is selected as the recommended plan for a user currently subscribed to Plan 5 who's average consumption amount of printing sheets (papers) during the determination period is 180 sheets. In this case, the amount of savings is 920 yen, which is found by subtracting the cost of 700 yen based on Plan 3 from the projected cost of 1620 yen (9 yen/month*180 sheets) based on Plan 5.

As described above, the amount of savings included in the guidance message corresponds to either information indicating how much a user not currently subscribed to a subscription plan can save by newly subscribing to a subscription plan or information indicating how much the user can save by switching the user's current plan to a different plan. The guidance message may also include information that directly describes the act of newly subscribing to a subscription plan from the current state of not being subscribed to a subscription plan or the act of changing the user's current plan to a different plan. For example, the guidance message in the former case may include text such as “Since you are currently not subscribed to a subscription plan” while the guidance message in the latter case may include text such as “Since you are currently subscribed to Plan 1.”

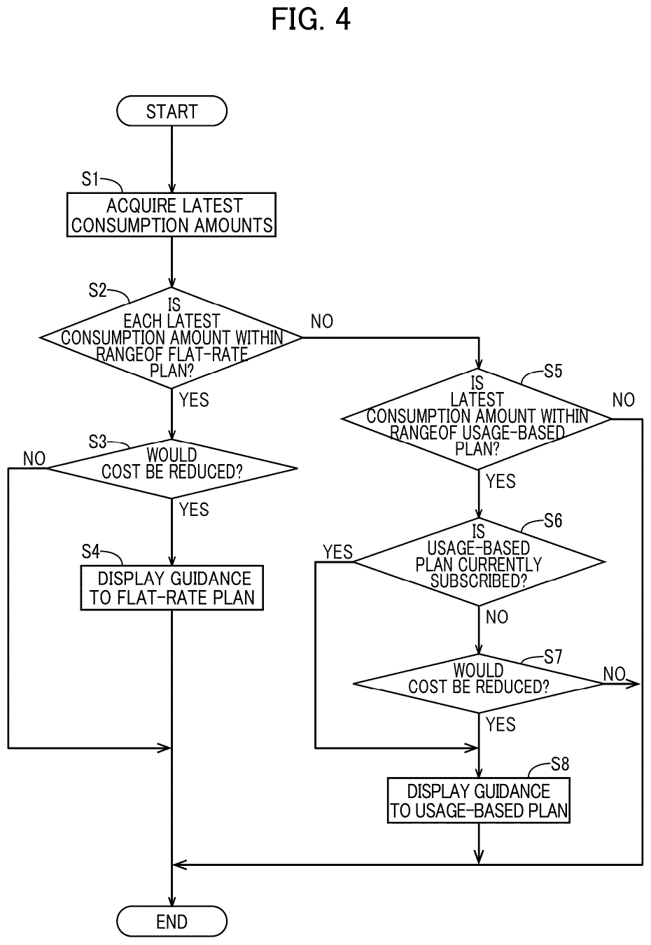

Next, an example of the process executed by the controller 30 will be described with reference to FIG. 4. In S1 at the beginning of this process, the controller 30 acquires each latest consumption amount in the determination period. As described above, the latest consumption amount is calculated based on the cumulative consumption amount acquired at the starting point of each unit period within the determination period, and the cumulative consumption amount acquired at the ending point of each unit period. Each latest consumption amount is an example of a consumption status. The controller 30 may directly acquire, as the consumption status, information including latest consumption amounts or may acquire history information on time-series consumption data from which the controller 30 can extract each latest consumption amount in the determination period.

In S2 the controller 30 determines whether each latest consumption amount acquired in S1 is within the fluctuation range of a flat-rate plan. The controller 30 makes this determination by determining whether condition (1) described above is satisfied. The controller 30 makes the determination as to whether condition (1) is satisfied for each flat-rate plan. When the controller 30 determines that each latest consumption amount is within the range of a flat-rate plan for at least one flat-rate plan (S2: YES), in S3 the controller 30 determines whether the user's cost would be reduced by one of the Plans 1-3 that satisfies condition (1). The controller 30 makes this determination based on whether condition (3) described above is satisfied. When the controller 30 determines that the cost would be reduced (S3: YES), in S4 the controller 30 displays, on the display 20, a guidance message (see FIG. 3A) showing the recommended plan that the controller 30 determined would reduce the user's costs. The guidance message may indicate that the recommended plan would reduce the user's cost. Here, when the controller 30 determines that the user's cost would be reduced by two (or a plurality of) the Plans 1-3, the controller selects a plan having smallest monthly fee as the recommended plan among the two of (the plurality of) the Plans 1-3. This process of S4 corresponds to the “first detailed plan notification process” and the “first-type specific plan notification process” of the present disclosure. When the controller 30 determines that no plan would reduce cost (S3: NO), the controller 30 ends the process in FIG. 4 without displaying a guidance message for a recommended plan on the display 20.

When the controller 30 determines in S2 that at least one latest consumption amount does not fall within the fluctuation range of each flat-rate plan (S2: NO), the controller proceeds to S5. That is, the controller 30 proceeds to S5 when there is no flat-rate plan for which each latest consumption amount falls within the fluctuation range. In S5 the controller 30 determines whether at least one latest consumption amount falls within the range of a usage-based plan. The controller 30 makes this determination based on whether condition (2) described above is satisfied. Further, the controller 30 makes this determination for each usage-based plan. When the controller 30 determines that no latest consumption amount is within the range of each usage-based plan, that is, there is no latest consumption amount within the range for each usage-based plan (S5: NO), the controller 30 ends the process in FIG. 4 without displaying a guidance message for a recommended plan on the display 20. However, when the controller 30 determines that a latest consumption amount is within the range of a usage-based plan (S5: YES), in S6 the controller 30 determines whether the plan to which the user is currently subscribed is a usage-based plan. When the controller 30 determines that the user is currently subscribed to a usage-based plan (S6: YES), in S8 the controller 30 displays a guidance message for a usage-based plan on the display 20 without making any cost-related determinations in S7 described later. This is the process performed in the exception case described above. When there is two or more plans satisfying condition (2), the guidance message displayed in this process recommends the plan among Plans 4-6 that has the largest determination reference value satisfying formula 2 of condition (2).

On the other hand, when the controller 30 determines in S6 that the user is not currently subscribed to a usage-based plan (S6: NO), in S7 the controller 30 determines whether the user's costs would be reduced by the plan among Plans 4-6 having the largest determination reference value that satisfies formula 2 of condition (2). The controller 30 makes this determination based on whether condition (3) described above is satisfied. When the controller 30 determines that the user's costs would be reduced (S7: YES), in S8 the controller 30 displays a guidance message (see FIG. 3B) on the display 20 describing the recommended plan that the controller 30 determined would reduce the user's costs. On the other hand, when the controller 30 determines that the user's costs would not be reduced (S7: NO), the controller 30 ends the process in FIG. 4 without displaying a guidance message for a recommended plan on the display 20.

According to the first embodiment described above, a guidance message introducing a recommended plan is displayed on the display 20 in accordance with the user's latest consumption amount(s) of printing paper. Accordingly, the printer 1 can assist the user in selecting a suitable subscription plan based on how the user uses the printer 1.

At this time, the printer 1 takes into account whether the user is currently subscribed to a plan when selecting a recommended plan. Therefore, the printer 1 can assist users in selecting a suitable subscription plan for both users not currently subscribed to a plan and users already subscribed to a plan.

In accordance with conditions (1) and (2) described above in the embodiment, the printer 1 selects either a flat-rate plan or a usage-based plan depending on whether the user's consumption amount of printing sheets (papers) fluctuates to a large or small degree. Accordingly, the printer 1 selects the recommended plan most suited to the user's pattern of use. Of Plans 1 through 6 described in the embodiment, Plans 1-3 are flat-rate plans while Plans 4-6are usage-based plans. A determination reference value is set for each of these Plans 1-6. The printer 1 selects one of the Plans 1-6 as a candidate for recommendation depending on whether the user's latest consumption amount(s) satisfies conditions based on the plan's determination reference value. Hence, the printer 1 selects a suitable plan to recommend to the user according to the terms of the plan. Further, the printer 1 displays a guidance message for the recommended plan on the display 20 only when a subscription to this recommended plan would reduce the user's costs according to condition (3) described above. Accordingly, the printer 1 can guide the user in selecting a suitable plan for reducing ink consumption costs.

### Second Embodiment

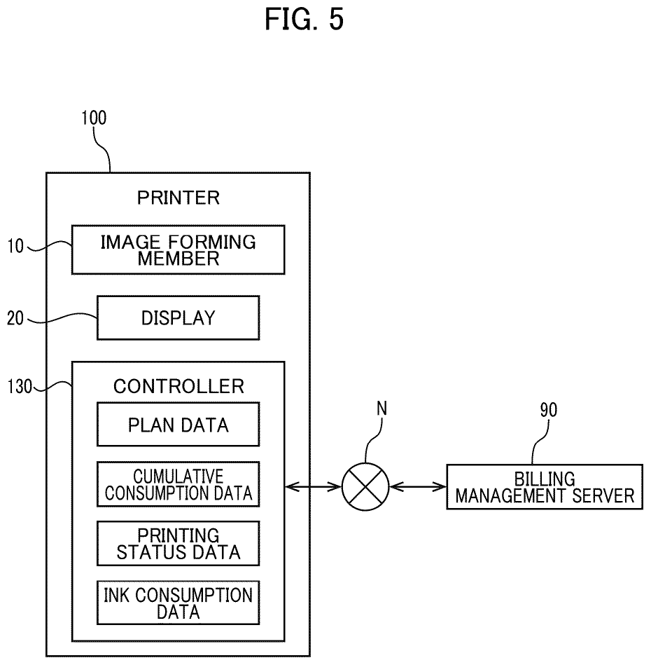

A printer 100 according to a second embodiment will be described while referring to FIG. 5. The basic structures in the second embodiment are identical to those in the first embodiment, only the differences will be described below wherein like parts and components are designated with the same reference numerals to avoid duplicating description.

The printer 100 has the image forming member 10, the display 20, and a controller 130. The controller 130 is provided with hardware, such as a storage configured of a CPU, ROM, and RAM; an ASIC; and the like. The ROM stores program data executed by the CPU and the ASIC, and the like. The RAM stores instruction data for image formation described below, and data used by the CPU to execute programs. The CPU and ASIC, which are hardware, execute various processes including processes to control the operations of the image forming member 10 and display 20 in accordance with the program data, which is software stored in the ROM and RAM, and other data.

The controller 130 maintains plan data, cumulative consumption data, printing status data, and ink consumption data. Of these, the cumulative consumption data is the same as that in the first embodiment. The printing status data includes data indicating an aggregate value for printing quality and an ink usage rate per sheet. The aggregate value for printing quality specifies the number of times a print quality mode was used previously in image formation. This information is acquired based on the print quality specified in image data. Specifically, there are two mode settings for print quality used in image formation: a high-quality mode and a low-quality mode. The image data specifies which of these modes is to be used. Each time image formation is performed according to image data, the controller 130 uses the print quality mode indicated in the image data and tabulates the print quality mode used for image formation. In other words, for each print quality mode, the controller 130 counts the total number of times the image formation is performed according to the print quality mode. In this way, the controller 130 obtains aggregate values such as N1 times for the high-quality mode and N2 times for the low-quality mode.

The ink usage rate per sheet corresponds to the ratio of ink coverage to the entire area of one sheet of printing paper, where ink corresponds to the “colorant” of the present disclosure. The controller 130 calculates the ink usage rate per sheet in each image formation operation based on the image data. The controller 130 maintains the ink usage rate per sheet in a plurality of image forming processes as printing status data. The controller 130 calculates the ink usage rate per sheet based on a rate of an area of a total ink-deposited region to an area of a total sheet region. Here, the total ink-deposited region is a region within which ink has been deposited in the plurality of image forming processes, and the total sheet region is a region of the sheets printed in the plurality of image forming processes. The ink consumption data denotes the cumulative amount of ink consumption. This information is acquired based by counting the number of times ink is ejected from the inkjet head 13 during image formation, for example.

The plan data describes information related to subscription plans. As in the first embodiment, a subscription plan is a service in which the manufacturer or other entity provides the user with ink cartridges 12 and charges a fee for an amount based on the number of sheets of printing paper consumed during image formation. Subscription plans may be one or both of the flat-rate plans and usage-based plans described in the first embodiment or may be plans different from these. The plan data may also include data specifying the determination reference value for each plan. The determination reference value corresponds to the “predetermined threshold value” of the present disclosure and is a reference value related to the amount of ink consumed for the number of sheets of printing paper consumed.

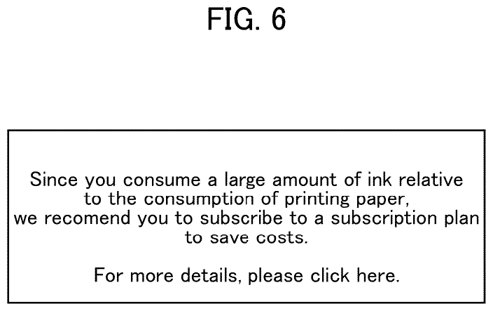

The controller 130 evaluates the amount of ink consumption for the number of sheets of printing paper consumed based on at least one of the cumulative consumption data, the printing status data, and the ink consumption data. Specifically, the controller 130 calculates an evaluation value as one of the following values (a)-(c) and compares this evaluation value to the determination reference value. When the evaluation value is greater than or equal to the determination reference value, the controller 130 displays a guidance message such as that shown in the example of FIG. 6 on the display 20. The guidance message recommends the user to subscribe to a subscription plan. On the other hand, when the evaluation value is less than the determination reference value, the controller 130 does not display the above guidance message.
(a) a value obtained by dividing an ink consumption amount during a prescribed time interval by the consumption amount of printing sheets (papers) during the same time interval
(b) a value obtained by dividing the number of times the high-quality mode was selected in the image data in a prescribed time interval by the number of image forming operations executed in the prescribed time interval (corresponding to the “selection rate” of the present disclosure)
(c) the ink usage rate per sheet of paper

When calculating one of the evaluation values in (a)-(c), the quantity of a consumable in the prescribed time interval is obtained based on the cumulative consumption amounts at the starting point and ending point of the prescribed time interval.

According to the second embodiment described above, subscription plans charge a fee for the consumption of printing sheet (paper) while the ink cartridges 12 are provided separately. Such subscription plans are suitable for users who consume a large amount of ink relative to the consumption amount of printing sheets (papers). Each of the values in (a)-(c) represents the amount of ink consumption relative to the consumption amount of printing sheets (papers). Therefore, by using any of the values (a)-(c), the controller 130 can suitably recommend whether the user should subscribe to a subscription plan based on the manner in which the user uses the printer 100.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Variation 1

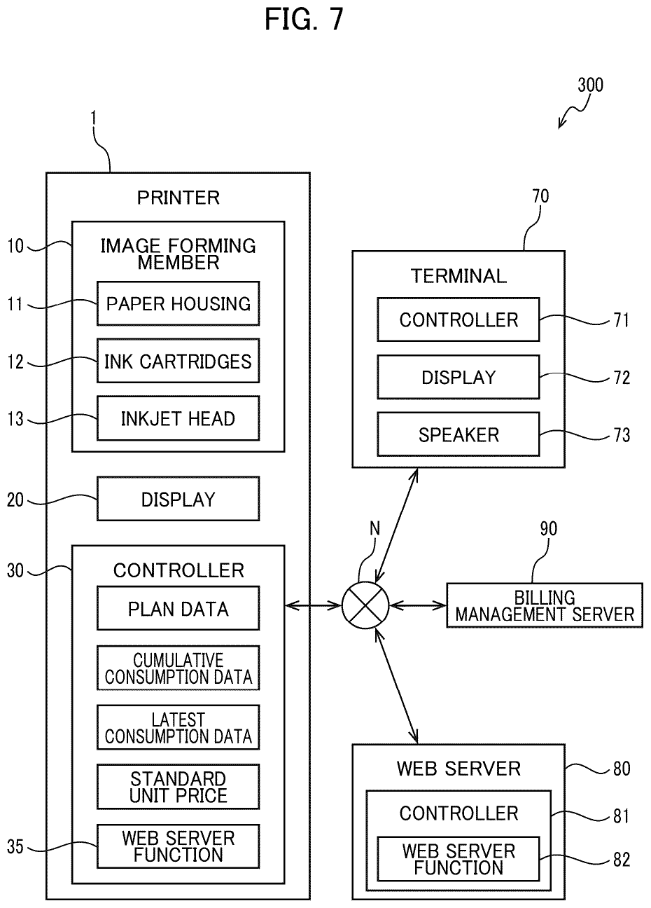

FIG. 7 is a block diagram illustrating a printing system 300 as a variation, wherein components identical to those in the first embodiment are designated with the same reference numerals for referencing prior descriptions. The printing system 300 includes the printer 1, the billing management server 90, and a terminal (terminal device) 70. The printer 1 and the terminal 70 are connected through the communication network N. The printing system 300 may further include a web server 80 that are connected to the communication network. However, the printing system 300 may not include the web server 80 in this variation 1. The printer 1 may further possess a server function 35 as shown in FIG. 7. However, the printer 1 may not possess the server function 35 in the variation 1.

The terminal 70 is computer hardware such as a personal computer (PC) or a smartphone. The terminal 70 includes a controller 71, a display 72 displaying image. The terminal 70 may further includes a speaker 73 making a sound. However, the terminal 70 may not include the speaker 73 in this variation 1. The controller 71 is provided with hardware, such as a central processing unit (CPU); a storage configured of a read-only memory (ROM) and/or a random-access memory (RAM); and/or an application-specific integrated circuit (ASIC). The ROM stores program data executed by the CPU and the ASIC, and other data. The RAM stores instruction data for image formation described later, and data used by the CPU to execute programs. The CPU and ASIC are processors.

The controller 30 of this variation 1 performs the process shown in FIG. 4. However, the controller 30 controller transmits an email in each of the processes of S4 and S8 in place of displaying the guidance message on the display 20.

Specifically, in S4 the controller sends an email to the terminal 70. In this case, the email includes guidance information specifying the recommended plan (one of Plans 1-3) that the controller 30 determined to reduce the user's cost in S3, and/or information that that recommended plan would reduce the user's costs. Upon receipt of this email, the controller 71 of the terminal 70 controls the display 72 to display the email describing the recommended plan and/or a message describing that the recommended plan would reduce the user's costs.

Similarly, in S8 the controller 30 sends, to the terminal 70, an email including guidance information specifying the recommended plan (one of Plans 4-6) that the controller 30 determined to reduce the user's cost in S7, and/or information indicating that that recommended plan would reduce the user's costs. Upon receipt of this email, the controller 71 of the terminal 70 controls the display 72 to display the email describing the recommended plan and/or a message describing that the recommended plan would reduce the user's costs.

### Variation 2

As shown in FIG. 7, the printing system 300 of a variation 2 includes the printer 1, the billing management server 90, and the terminal 7. The web server 80 may be unnecessary in this variation 2. The terminal 7 may include the speaker 73 in this variation 2. The terminal 7 can communicate with the printer 1 through the communication network N.

In the variation 2, the controller 30 possesses the server function 35 such as an Embedded Web Server (EWS).

The controller 30 of this variation 2 performs the process shown in FIG. 4. However, in S4 the server function 35 of the controller 30 transmits guidance information to the terminal 70 according to Hypertext Transfer Protocol (HTTP) or Hypertext Transfer Protocol Secure (HTTPS). Specifically, a web browser running on the terminal 70 through control of the controller 71 can access the server function 35. When the server function 35 of the printer 1 receives a first specific request from the terminal 70 through HTTP or HTTPS, in S4 in response to reception of the first specific request, the server function 35 transmits the guidance information to the web browser of the terminal 70. The guidance information includes information indicating the recommended plan that the controller 30 determined to reduce the user's cost in S3 and/or information indicating that the recommended plan would reduce the user's costs. The guidance information may include an instruction to perform a notification based on that information in the guidance information. Upon receipt of this guidance information, the controller 71 of the terminal 70 controls the display 72 to display a message describing the recommended plan and/or a message describing that the recommended plan would reduce the user's costs, based on the guidance information. The controller 71 may control the speaker 73 to speak a voice guidance of the recommended plan and/or a voice guidance that the recommended plan would reduce the user's costs, based on the received guidance information.

Similarly, when the server function 35 of the printer 1 receives a second specific request from the terminal 70 through HTTP or HTTPS, in S8 in response to reception of the second specific request, the server function 35 sends, to the terminal 70, guidance information specifying the recommended plan (one of Plans 4-6) that the controller 30 determined to reduce the user's cost in S7, and/or information that that recommended plan would reduce the user's costs. The guidance information may include an instruction to perform a notification based on that information in the guidance information. Or, the notification information may include an instruction to present (display, or make sound of, for example) the information included in the notification. Upon receipt of this guidance information, the controller 71 of the terminal 70 controls the display 72 to display a message describing the recommended plan and/or a message describing that the recommended plan would reduce the user's costs, based on the guidance information. The controller 71 may control the speaker 73 to speak a voice guidance of the recommended plan and/or a voice guidance indicating that the recommended plan would reduce the user's costs, based on the received guidance information.

### Variation 3

As shown in FIG. 7, the printing system 300 of a variation 3 includes the printer 1, the billing management server 90, the terminal 7, and the web server 80. The web server 80 can communicate with the printer 1 and the terminal 7 through the communication network N. The controller 30 may not possess the server function 35 in the variation 3.

The web server 80 includes a controller 81. The controller 81 is provided with hardware, such as a central processing unit (CPU); a storage configured of a read-only memory (ROM) and/or a random-access memory (RAM); and/or an application-specific integrated circuit (ASIC). The ROM stores program data executed by the CPU and the ASIC, and other data. The RAM stores instruction data for image formation described later, and data used by the CPU to execute programs. The CPU and ASIC are processors. The controller 81 possesses a web server function 82 that receives requests and transmits responses according to HTTP or HTTPS.

In the variation 3, in place of the printer 1, the controller 81 of the web server 80 performs the process shown in FIG. 4. However, in S4 the server function 82 of the controller 81 transmits guidance information to the terminal 70 according to HTTP or HTTPS.

Specifically, the web browser running on the terminal 70 through control of the controller 71 can access the server function 35. When the server function 82 receives a first specific request from the terminal 70 through HTTP or HTTPS, in S4 in response to reception of the first specific request, the server function 82 transmits the guidance information to the web browser of the terminal 70. The guidance information includes information indicating the recommended plan that the controller 81 determined to reduce the user's cost in S3 and/or information indicating that the recommended plan would reduce the user's costs. The guidance information may include an instruction to perform a notification based on that information in the guidance information. Or, the notification information may include an instruction to present (display, or make sound of, for example) the information included in the notification. Upon receipt of this guidance information, the controller 71 of the terminal 70 controls the display 72 to display a message describing the recommended plan and/or a message describing that the recommended plan would reduce the user's costs, based on the guidance information. The controller 71 may control the speaker 73 to speak a voice guidance of the recommended plan and/or a voice guidance that the recommended plan would reduce the user's costs, based on the received guidance information. In S4, the server function 82 may transmits the guidance information to the printer 1 so that the printer 1 displays the guidance information. Upon receipt of the guidance information, the controller 30 of the printer 1 controls the display 20 to display the guidance information.

Similarly, when the server function 81 receives a second specific request from the terminal 70 through HTTP or HTTPS, in S8 to in response to reception of the second specific request, the server function 81 sends, to the terminal 70, guidance information specifying the recommended plan (one of Plans 4-6) that the controller 81 determined to reduce the user's cost in S7, and/or information that that recommended plan would reduce the user's costs. The guidance information may include an instruction to perform a notification based on that information in the guidance information. Upon receipt of this guidance information, the controller 71 of the terminal 70 controls the display 72 to display a message describing the recommended plan and/or a message describing that the recommended plan would reduce the user's costs, based on the received guidance information, based on the guidance information. Based on the received guidance information, the controller 71 may control the speaker 73 to speak a voice guidance of the recommended plan and/or a voice guidance indicating that the recommended plan would reduce the user's costs. In S8, the server function 82 may transmits the guidance information to the printer 1 so that the printer 1 displays the guidance information. Upon receipt of the guidance information, the controller 30 of the printer 1 controls the display 20 to display the guidance information.

The web server 80 may possess a print server function managing printing requests for the printer 1 received via the network to which the printer 1 is connected.

The billing management server 90 may possess a server function the same as that of the server function 81. In this case, the billing management server 90 with the server function performs the process of FIG. 4 according to this variation 3. In this case the web server 80 may not be necessary.

### Variation 4

In the first embodiment described above, a recommended plan is selected based on the amount of consumed printing sheets (papers). However, the recommended plan may be selected based on a time-averaged consumption amount of printing sheets (papers). For example, condition (2) in the embodiment requires that the consumption amount of printing sheets (papers) in at least one unit period of the determination period exceeds the determination reference value for one of the usage-based plans. However, the criterion in this variation may be that the average consumption amount of printing sheets (papers) per month during the determination period exceeds the determination reference value.

### Variation 5

In the first embodiment described above, the printer 1 selects the recommended plan. In the second embodiment described above, the printer 100 determines whether to display a guidance message recommending that the user subscribe to a subscription plan. As an alternative, a computer such as the billing management server 90 different from printers 1 and 100 may perform these processes. For example, the printer 1 may transmit the latest consumption amounts to the computer, and the computer may select a recommended plan based on the latest consumption amounts, as with the process in the first embodiment. The computer may also display the guidance message or transmit, to a device such as the printer 1, an instruction to make a notification of the guidance message. Further, a print server may be used as the computer. A print server manages printing requests for the printer 1 received via the network to which the printer 1 is connected. In this case, as in the second embodiment described above, the print server may tabulate print quality settings in the print requests and may instruct the printer 1 to display a guidance message recommending that the user subscribe to a subscription plan on the basis of the tabulation results. The print server may control or instruct a terminal device such as a PC or smartphone to display the guidance message on a display in the terminal device.

### Variation 6

In the first embodiment described above, the printer 1 evaluates the degree of fluctuation in the consumption amount of printing sheets (papers), as specified in condition (1). However, this degree of fluctuation may be evaluated using a different method. For example, the printer 1 may determine that the degree of fluctuation in consumption amount is small when the average amount of printing paper consumed per month over the determination period falls within a prescribed range and the variance of the consumption amount of printing sheets (papers) in each unit period is no greater than a prescribed value.

### Variation 7

In the first embodiment described above, the display 20 serves as the notification member of the disclosure. However, a notification member may be employed through other means instead of or in addition to the display 20. For example, the notification of information may be achieved through audio output from a speaker or through the printing of information on printing paper.

### Variation 8

In the first embodiment described above, the criterion for condition (2) is that the consumption amount of printing sheets (papers) during at least one of the unit periods exceeds the determination reference value for one of the usage-based plans. In other words, condition (2) is satisfied when the consumption amount of printing sheets (papers) in a unit period exceeds the determination reference value even one time during the determination period. Alternatively, the printer 1 may employ a condition requiring the consumption amount of printing sheets (papers) during a unit period to exceed the determination reference value N times (where N is a natural number of 2 or greater) within the determination period. That is, the condition is that the latest consumption amount of printing sheet (paper) within a unit period exceeds N times among the latest consumption amounts within the determination period. This condition corresponds to the condition of the present disclosure requiring that “the number of times the consumption amount of the consumable in a unit period of prescribed duration, or the time-average thereof, exceeds the lower threshold (or threshold) must be at least a predetermined number of consecutive unit periods.”

### Variation 9

In the above embodiments, guidance information of a subscription plan, and specifically a guidance message of a recommended plan or a guidance message recommending subscribing to a subscription plan, is displayed on the display 20. However, other information related to the subscription plan may be displayed on the display 20 instead. For example, when the printer 1 has both a Model A that supports Plans 1-3 and a Model B that does not support Plans 1-3 and Plan 1 was selected as the recommended plan by a Model B printer 1, the printer 1 may display a guidance message on the display 20 that, instead of recommending a plan, recommends the user install a Model A printer 1.

### Variation 10

The subscription plans in the embodiments described above charge a fee according to the amount of printing paper consumed. However, the present invention may be applied to subscription plans that charge a fee based on the consumption of ink instead. In this case, the printer detects the amount of ink consumed in every image forming operation, totals the detection results as the cumulative ink consumption amount, and selects a recommended plan based on this cumulative consumption amount.

### Variation 11

Additionally, each of the above embodiments describes the printer 1 or 100, but the present invention is not limited to these configurations. The present invention may be applied to other inkjet-based image forming devices that eject ink from a head, such as multifunction peripherals or copiers. The present invention may also be applied to laser-based image forming devices that perform image recording processes by depositing toner on printing paper instead of by depositing ink on printing paper, as described in the inkjet method. In this case, toner cartridges accommodating toner are removably mounted in the image forming device. In this case, the fee may be charged based on a consumption amount of toner instead of a consumption amount of ink.

The configurations, methods or processes according to the embodiments and the variations described above may be used in suitable combinations in addition to those already described.

What is claimed is:

1. An image forming device comprising:
a printing engine configured to print an image on a sheet;
a notification member; and
a controller configured to perform:
acquiring a consumption status including information on a consumption amount of consumable material consumed by the printing engine; and
a notification process to control the notification member to issue a notification based on the consumption amount of consumable material, the notification including notification information related to a subject price plan in which a fee is set for consumption of consumable material.

2. The image forming device according to claim 1, wherein the notification information is related to a guidance on the subject price plan.

3. The image forming device according to claim 1, wherein the notification information is related to a guidance on subscription to the subject price plan for a target account currently having no subscription to any price plan.

4. The image forming device according to claim 1, wherein the notification information is related to a guidance for changing a currently-subscribed price plan to the subject price plan, the subject price plan being selected from a plurality of specific price plans.

5. The image forming device according to claim 1, wherein the controller is configured to perform:
setting the subject price plan to a selected specific-type price plan, the selected specific-type price plan being a price plan in which a flat fee is charged for consumption of consumable material up to a first reference amount during a predetermined time period and an additional fee is charged for consumption of consumable material beyond the first reference amount during the predetermined time period.

6. The image forming device according to claim 5, wherein the additional fee is calculated by multiplying a unit price by the consumption of consumable material beyond the first reference amount during the predetermined time period, the unit price being larger than a value obtained by dividing the flat fee by the first reference amount.

7. The image forming device according to claim 5, wherein the controller is configured to further perform:
a comparing process to compare a consumption value with a second reference amount set for the selected specific-type price plan, the consumption value being the consumption amount of consumable material or a time average based on the consumption amount of consumable material,
wherein when a result of the comparing process indicates that the consumption value falls within a variation range, the controller performs the notification process with the subject price plan set to the selected specific-type price plan.

8. The image forming device according to claim 6, wherein the variation range has an upper limit and a lower limit, the upper limit and the lower limit being both based on the second reference amount,
wherein the consumption amount of consumable material is an amount of consumable material consumed during a predetermined second time period, and the time average is an average of an amount of consumable material consumed per the predetermined second time period.

9. The image forming device according to claim 7, wherein the selected specific-type price plan is selected from a plurality of specific-type price plans, each of the plurality of specific-type price plans having a respective one of a plurality of flat fees, a respective one of a plurality of first reference amounts, and a respective one of a plurality of variation ranges, the selected specific-type price plan having the variation range within which the consumption value falls.

10. The image forming device according to claim 1, wherein the controller is configured to further perform:
a fee projection process to calculate a projected fee; and
a comparing process to compare the projected fee with the fee of the subject price plan,
wherein when the fee of the subject price plan is less than the projected fee, the controller performs the notification process,
wherein under a first situation that a target account currently has a subscription to a price plan as a current price plan, the projected fee is based on the current price plan whereas under a second situation that the target account currently has no subscription to any price plan, the projected fee is a fee projected under an assumption that the second situation is maintained.

11. The image forming device according to claim 1, wherein the controller is configured to perform:
setting the subject price plan to a selected specific-type price plan in which a predetermined fee is charged for a predetermined amount of consumable material.

12. The image forming device according to claim 11, wherein the controller is configured to further perform:
a comparing process to compare a consumption value with a reference amount, the consumption value being the consumption amount of consumable material or a time average based on the consumption amount,
wherein when a result of the comparing process indicates that the consumption value does not fall within a variation range, the controller performs the notification process with the subject price plan set to the selected specific-type price plan.

13. The image forming device according to claim 12, wherein the variation range has an upper limit and a lower limit, the upper limit and the lower limit being both based on the reference amount,
wherein the consumption amount of consumable material is an amount of consumable material consumed during a predetermined first time period and the time average is an average of an amount of consumable material consumed per the predetermined first time period.

14. The image forming device according to claim 13, wherein the selected specific-type price plan is selected from a plurality of specific-type price plans, each of the plurality of specific-type price plans having a respective one of a plurality of predetermined fees and a respective one of a plurality of thresholds, the selected specific-type price plan being a specific-type price plan having a largest threshold of the plurality of thresholds among the plurality of specific-type price plans satisfying a predetermined condition,
wherein the predetermined condition includes a requirement that a number of exceeding amounts is larger than or equal to a predetermined number or a requirement that a time-average exceeds a predetermined value, each of the exceeding amounts being an amount of consumable material exceeding the threshold of a corresponding specific-type price plan among a plurality of unit-period-based amounts of consumable material, each of the plurality of unit-period-based amounts of consumable material being an amount of consumable material consumed during a respective one of a plurality of unit time periods successively arranged within a total time period, each of the unit time periods having a predetermined length, the time-average being an average per unit time based on a total amount of the plurality of unit-period-based amounts of consumable material over the total time period,
wherein the controller performs the notification process with the subject price plan set to the selected specific-type specific plan.

15. The image forming device according to claim 1, wherein the subject price plan in which: the fee is charged for consumption of sheets; and colorant in use for printing images by the printing engine is supplied.

16. The image forming device according to claim 15, wherein the consumption amount of consumable material is an amount of consumed sheets,
wherein the controller is configured to further perform:
selecting the subject price plan from among a plurality of price plans based on a ratio of an amount of consumed colorant to the amount of consumed sheets.

17. The image forming device according to claim 15, wherein the consumption amount of consumable material is an amount of consumed sheets,
wherein the controller is configured to further perform:
selecting the subject price plan from among a plurality of price plans based on a ratio of an area of a total colorant-deposited region to an area of a total sheet region, the total sheet region being a total region of all the consumed sheets, the total colorant-deposited region being a part of the total sheet region on which colorant is deposited.

18. The image forming device according to claim 1, wherein the printing engine is configured to performing printing on the sheet in a selected one of a low quality mode and a high quality mode in which an image quality of printing is higher than an image quality in the low quality mode,
wherein when a number of times printing has been performed in the high quality mode is larger than or equal to a predetermined threshold value, the controller performs the notification process.

19. An image forming system comprising:
an image forming device including:
a printing engine configured to print an image on a sheet; and
a notification member,
a processing device configured to communicate with the image forming device, the processing device including:
a controller configured to perform:
acquiring a consumption status including information on a consumption amount of consumable material consumed by the printing engine; and
a sending process to send, to the image forming device, a notification based on the consumption amount of consumable material, the notification including notification information related to a subject price plan in which a fee is set for consumption of consumable material,
wherein upon receipt of the notification from the processing device, the notification member presents the notification information in the notification.

20. A processing device configured to communicate with an image forming device, the processing device including:
a controller configured to perform:
acquiring a consumption status including information on a consumption amount of consumable material consumed by a printing engine in the image forming device; and
a notification process to send, to an external device, a notification including notification information based on the consumption amount of consumable material so that the external device presents the notification information, the notification information being related to a subject price plan in which a fee is set for consumption of consumable material.
